(19) United States
(12) Patent Application Publication
(10) Pub. No.: US 2025/0256832 A1
(43) Pub. Date: Aug. 14, 2025

(54) Folding Wingtip

(71) Applicant: The Boeing Company, Arlington, VA (US)

(72) Inventors: Steven Paul Walker, Arlington, WA (US); Matthew Edmunds, Marysville, WA (US); Patrick Tang, Seattle, WA (US)

(21) Appl. No.: 18/439,337

(22) Filed: Feb. 12, 2024

(51) Int. Cl. B64C 3/56

(52) U.S. Cl. CPC B64C 3/56

(57) ABSTRACT

A folding wingtip and method for folding said wingtip. The folding wingtip includes a multi-spar main box and a hinge fitting attached to the inboard end of each spar. A hinge line passes through each hinge fitting perpendicular to each spar. The wingtip is connected to a main section of an aircraft wing and is foldable with respect to the main section about the hinge line.

### BACKGROUND INFORMATION

### 1. Field

The present disclosure relates generally to folding wingtips of aircraft. More specifically, the present disclosure relates to a multi-spar folding wingtip where the spars are perpendicular to a hinge line of the folding wingtip and bending loads of the folding wingtip are carried in the spars allowing for greater span length.

### 2. Background

Aircraft with folding wingtips address unique operational and spacing issues faced at airports and maintenance facilities. For example, in order to increase airport revenues, it may be desired to fit more aircraft gates at terminals into a preexisting airport footprint. In essence, a folding wingtip temporarily narrows the wing span of the aircraft, reducing the amount of space the aircraft occupies, thus allowing more aircraft to be fit side by side at airport terminals that have only a predetermined amount of gate space. Additionally, a folding wingtip allows for increasing the wing span of an aircraft during operation which increases aerodynamic efficiency and reduces fuel burn resulting in operating cost savings.

Current folding wingtip designs incorporate interlocking torque boxes and reinforced skin panels requiring multiple points of load transfer. The designs significantly increase the weight of the wing and thus are costly to manufacture and operate. Because of strength requirements, the design does not scale down to fit in a smaller structure.

Therefore, it would be desirable to have a method and apparatus that takes into account at least some of the issues discussed above, as well as other possible issues.

### SUMMARY

An illustrative embodiment of the present disclosure provides a folding wingtip. The folding wingtip includes a spar, a hinge fitting, and a hinge line. The hinge fitting is connected to an inboard end of the spar. The hinge line passes through the hinge fitting perpendicular to the spar. The hinge line is a pivot axis for the folding wingtip.

Another illustrative embodiment of the present disclosure provides an aircraft wing with a folding wingtip. The aircraft wing includes a main section and a wingtip section. The main section of the aircraft wing is connected to a fuselage of an aircraft. The wingtip section of the aircraft wing is connected to the main section. The wingtip section includes at least three spars arranged in parallel with each other, a respective hinge fitting connected to a respective inboard end of each spar, and a hinge line. Each respective hinge fitting is pivotally connected to the main section. The hinge line is perpendicular to each spar. The hinge line is a pivot axis for folding the spars and respective hinge fittings relative to the main section of the aircraft wing.

A further illustrative embodiment of the present disclosure provides a method for folding a wingtip. A wingtip section of an aircraft wing is provided connected to a main section of the aircraft wing. The wingtip section comprises at least three spars arranged parallel with each other and a respective hinge fitting connected to a respective inboard end of each spar. A hinge line of the wingtip section is aligned perpendicular to the spars of the wingtip section. The hinge line passes through each respective hinge fitting. An actuator is activated such that the wingtip section folds about the hinge line. The hinge line provides a pivot axis for the wingtip section relative to the main section.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of a platform in accordance with an illustrative embodiment;

FIG. 2 is an illustration of a folding wingtip in accordance with an illustrative embodiment;

FIG. 3 is an illustration of a set of spars of a folding wingtip in accordance with an illustrative embodiment;

FIG. 4 is an illustration of a set of hinge fittings connected to a set of spars in accordance with an illustrative embodiment;

FIG. 5 is an illustration a main section of a wing of an aircraft connected to a set of spars and hinge fittings in accordance with an illustrative embodiment;

FIG. 6 is an illustration a set of latch pins in accordance with an illustrative embodiment;

FIG. 7 is an illustration of a folding wingtip in a deployed position and a folded position in accordance with an illustrative embodiment;

FIG. 8 is an illustration of a flowchart of a process for folding a wingtip in accordance with an illustrative embodiment;

FIG. 9 is an illustration of a block diagram of an aircraft manufacturing and service method in accordance with an illustrative embodiment; and

FIG. 10 is an illustration of a block diagram of an aircraft in which an illustrative embodiment may be implemented.

### DETAILED DESCRIPTION

The illustrative embodiments recognize and take into account one or more different considerations. For example, the illustrative embodiments recognize and take into account that an aircraft wing that is foldable provides advantages such as space saving and operational efficient upgrades.

The illustrative embodiments also recognize and take into account that current folding wingtip designs prioritize reducing aerodynamic drag on the folded wingtip during locomotion on the ground.

The illustrative embodiments also recognize and take into account that current folding wingtip designs may not be possible on today's smaller commercial aircraft due to space constraints within the wing and/or damage tolerance requirements.

The illustrative embodiments also recognize and take into account that current folding wingtip designs incorporate interlocking torque boxes and reinforced skin panels requiring multiple points of load transfer. The designs significantly increase the weight of the wing and thus are costly to manufacture and operate. The designs, because load is carried in the skins of the wing, are also expensive to repair if damage occurs to the wing during operation, storage, or ground transportation.

Thus, the illustrative embodiments provide a folding wingtip where the bending moment of the wingtip is carried in the spars of the wingtip. This is a departure from the usual practice of carrying the bending moment in the skins. The disclosed folding wingtip minimizes the loads transfer into hinge fittings connected to the spars which allows wingtip panels to be light enough to crush in the event of a wingtip collision when the wingtip is folded up protecting the main part of the wing from damage.

The illustrative embodiments provide a folding wingtip where the hinge line (or fold line) is perpendicular to the spars which provides more room inside the fixed wing section for latch pin actuators and allows greater separation between the fold line and the latch pins, which reduces the latch pin loads in flight. The disclosed design also distributes the forces more evenly between the multiple latch pins.

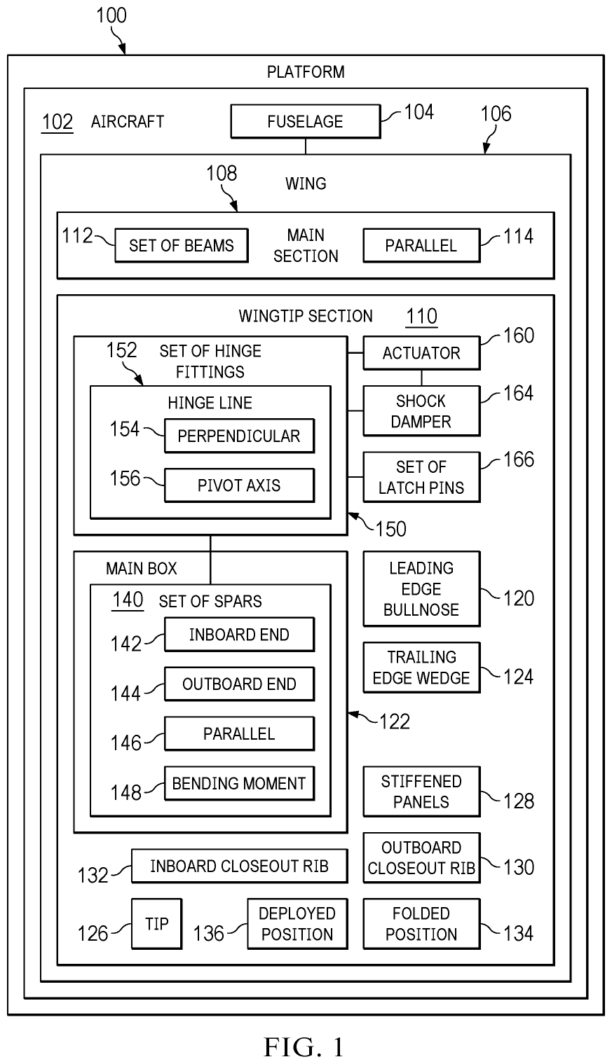

With reference now to the figures and, in particular, with reference to FIG. 1, an illustration of a block diagram of a platform is depicted in accordance with an illustrative example. Platform 100 has aircraft 102 in this illustrative example.

The illustration of aircraft 102 in FIG. 1 is not meant to imply physical or architectural limitations to the manner in which an illustrative example may be implemented. For example, although aircraft 102 may be a commercial aircraft, aircraft 102 may be a military aircraft, a rotorcraft, a helicopter, an unmanned aerial vehicle, or any other suitable aircraft.

Although the illustrative examples are described with respect to an aircraft, the illustrative example may be applied to other types of platforms. The platform may be, for example, a mobile platform, a stationary platform, a land-based structure, an aquatic-based structure, or a space-based structure. More specifically, the platform may be an aircraft, a surface ship, a tank, a personnel carrier, a train, a spacecraft, a space station, a satellite, a submarine, an automobile, a power plant, a bridge, a dam, a house, a manufacturing facility, a building, a tool, a mechanical structure, or some other suitable platform or structure where a folding wingtip is desirable.

In this illustrative example, platform 100 takes the form of aircraft 102. In this illustrative example, when platform 100 takes the form of aircraft 102, aircraft 102 includes fuselage 104 and wing 106. Wing 106 is connected to fuselage 104.

As used herein, a first component “connected to” or “coupled to” or “associated with” a second component means that the first component can be connected directly or indirectly to the second component. The connection is a physical association. In other words, additional components may be present between the first component and the second component. The first component is considered to be indirectly connected to the second component when one or more additional components are present between the two components. When the first component is directly connected to the second component, no additional components are present between the two components.

For example, a first component can be considered to be physically connected to a second component by at least one of being secured to the second component, bonded to the second component, mounted to the second component, welded to the second component, fastened to the second component, or connected to the second component in some other suitable manner. The first component also can be connected to the second component using a third component. The first component can also be considered to be physically connected to the second component by being formed as part of the second component, an extension of the second component, or both.

Wing 106 includes main section 108 and wingtip section 110. Wingtip section 110 folds with respect to main section 108.

Main section 108 of wing 106 includes set of beams 112. Each beam of set of beams 112 is arranged parallel 114 to each of the other beams of set of beams 112.

As used herein, a “set of,” when used with reference to items, means one or more items. For example, a “set of beams 112” is one or more beams.

As used herein, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Wingtip section 110 of wing 106 is pivotally connected to main section 108 of wing 106. Wingtip section 110 includes leading edge bullnose 120, main box 122, trailing edge 124, and tip 126. Stiffened panels 128 encase or cover leading edge bullnose 120, main box 122, trailing edge 124 to form an aerodynamic shape of wing 106.

Outboard closeout rib 130 caps the outboard ends of leading edge bullnose 120, main box 122, trailing edge wedge 124. Outboard closeout rib 130 connects tip 126 to leading edge bullnose 120, main box 122, and trailing edge wedge 124. Inboard closeout rib 132 caps the inboard ends of leading edge bullnose 120, main box 122, and trailing edge wedge 124. Wingtip section 110 is pivotable or foldable with respect to main section 108. As a result, wingtip section 110 has a folded position 134 and a deployed position 136. In folded position 134, wingtip section 110 is folded with respect to main section 108. In deployed position 136, wingtip section 110 is locked with respect to main section 108 and wing 106 is operational for flying. In other words, in deployed position 136, the position of wingtip section 110 relative to main section 108 provides a continuous curvature of wing 106.

Main box 122 includes set of spars 140. Set of spars 140 can be any number of spars. In an illustrative example set of spars 140 includes at least three spars. Each spar of set of spars 140 has inboard end 142 and outboard end 144. Each spar of set of spars 140 is arranged parallel 146 to each of the other spars of set of spars 140. Stiffened panels 128 cover set of spars 140 within main box 122. Set of spars 140 carry bending moment 148 of wingtip section 110. In solid mechanics, a bending moment is the reaction induced in a structural element when an external force or moment is applied to the element, causing the element to bend. When wingtip section 110 folds with respect to main section 108, set of spars 140 carries the majority of bending moment 148 associated with the weight of wingtip section 110 as it folds with respect to main section 108. A majority is defined in the typical sense to mean at least over half of bending moment 148, for example at least 51% to 100% of bending moment 148, is carried by set of spars 140. In contrast to current folding wingtip designs, bending moment 148 is carried in the spars rather than stiffened panels 128, with the stiffened panels only being relied on for aerodynamic pressure loads and torsional stiffness of wing 106.

Set of hinge fittings 150 are connected to set of spars 140. A respective hinge fitting of set of hinge fittings 150 is connected to an inboard end of each spar of set of spars 140. The inboard ends of each spar of set of spars 140 extends through inboard closeout rib 132. A respective hinge fitting of set of hinge fittings 150 is connected to each inboard end of each spar of set of spars 140 that extends through closeout rib 132. Hinge line 152 passes through each hinge fitting of set of hinge fittings 150. Because a respective hinge fitting of set of hinge fittings 150 is connected to the inboard ends of each spar of set of spars 140, hinge line 152 also passes through each inboard end of each spar of set of spars 140. Hinge line 152 is perpendicular 154 to each spar of set of spars 140. Hinge line 152 provides pivot axis 156 for folding wingtip section 110 with respect to main section 108.

Actuator 160 is mounted to set of hinge fittings 150 or set of beams 112. Actuator 160 motivates the movement of wingtip section 110 relative to main section 108 about hinge line 152. Shock damper 164 is mounted to set of hinge fittings 150 or set of beams 112. Shock damper 164 softens the movement of wingtip section 110 relative to main section 108. Shock damper 164 prevents abrupt starts and starts of the movement of wingtip section 110 relative to main section 108. Shock damper 164 prevents fatigue of wingtip section 110 if wingtip section 110 comes to a hard stop.

Set of latch pins 166 is removably engaged with set of hinge fittings 150. In an illustrated example, a respective latch pin of set of latch pins 166 is removably engaged with each respective hinge fitting of set of hinge fittings 150. Set of latch pins 166 engage set of hinge fittings 150 to secure wingtip section 110 in deployed position 136. In other words, when set of latch pins 166 is engaged with set of hinge fittings 150, wingtip section 110 cannot pivot about hinge line 152. In other words, when set of latch pins 166 is engaged with set of hinge fittings 150, set of spars 140 cannot fold about hinge line 152. Set of latch pins 166 are evenly distributed along hinge line 152. Set of latch pins 166 move with respect to set of hinge fittings 150 in a direction parallel with each spar of set of spars 140.

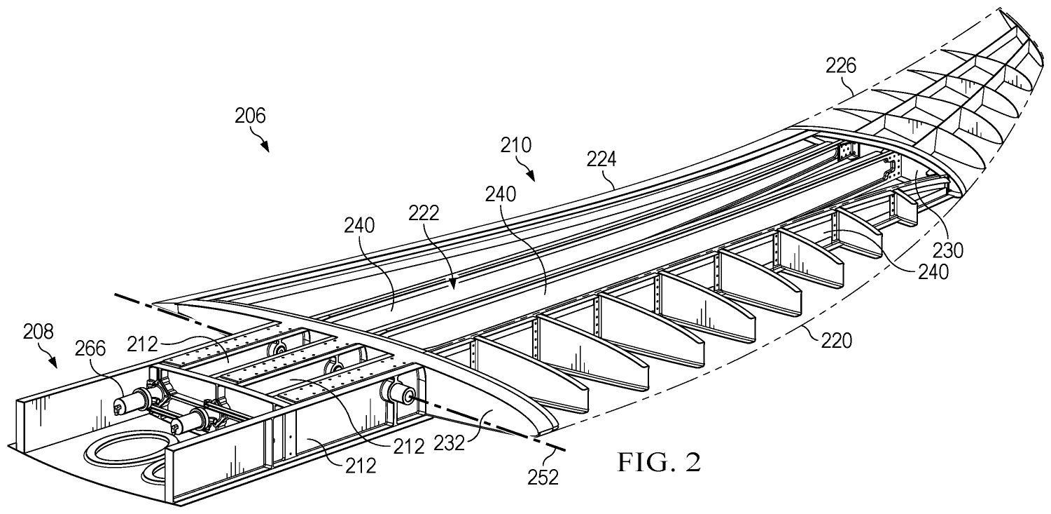

With reference next to FIG. 2, an illustration of a folding wingtip is depicted in accordance with an illustrative embodiment. In this illustrative example and the illustrative examples that follow, the same reference numeral may be used in more than one figure. This reuse of a reference numeral in different figures represents the same element in the different figures. The components illustrated in FIG. 2 are examples of physical implementations of main section 108 and wingtip section 110 of wing 106 of aircraft 102 shown in block form in FIG. 1.

As illustrated, wing 206 includes main section 208 and wingtip section 210. Main section 208 is connected to a fuselage of an aircraft. Additional components of wing 206 (not shown) may be present between main section 208 and the fuselage of the aircraft. Wingtip section 210 folds with respect to main section 208 about hinge line 252.

Main section 208 includes set of beams 212. Each beam of set of beams 212 is arranged parallel to each of the other beams of set of beams 212. Set of beams 212 are sized and shaped to fit between the respective hinge fittings. Hinge line 252 passes through each beam of set of beams 212.

Wingtip section 210 is pivotally connected to main section 208 of wing 206. Wingtip section 210 includes leading edge bullnose 220, main box 222, trailing edge 224, and tip 226. Stiffened panels (not shown) encase leading edge bullnose 220, main box 222, and trailing edge 224 to form an airfoil profile of wingtip section 210 and thus wing 206. Main box 222 includes set of spars 240. Each spar of set of spars 240 is parallel to each other.

Outboard closeout rib 230 caps the outboard ends of leading edge bullnose 220, main box 222, trailing edge wedge 224. Outboard closeout rib 230 connects tip 226 to leading edge bullnose 220, main box 222, and trailing edge wedge 224. Inboard closeout rib 232 caps the inboard ends of leading edge bullnose 220, main box 222, and trailing edge wedge 224. Set of spars 240 extends through inboard closeout rib 232 for connection with main section 208.

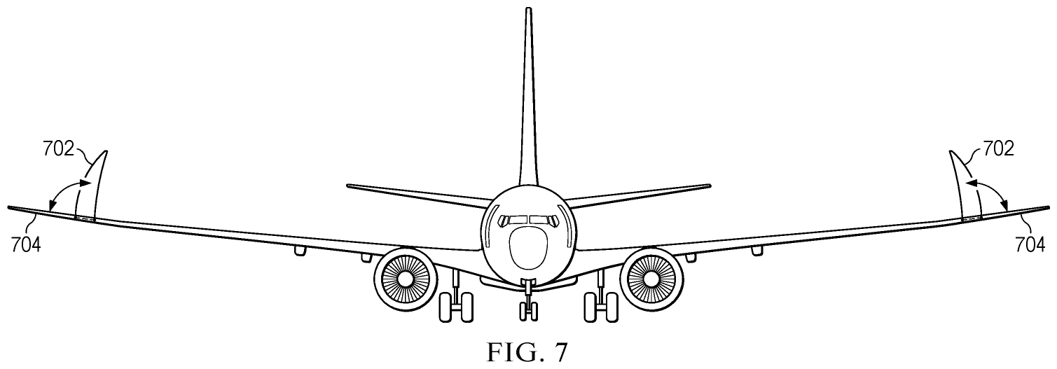

Wingtip section 210 is pivotable or foldable with respect to main section 208 about hinge line 252. Hinge line 252 is perpendicular to each spar of set of spars 240. As a result, wingtip section 210 has a folded position 702 (shown in FIG. 7) and a deployed position 704 (shown in FIG. 7). In folded position 702, wingtip section 210 is folded with respect to main section 208. In deployed position 704, wingtip section 210 is locked in an orientation suitable for flight operations.

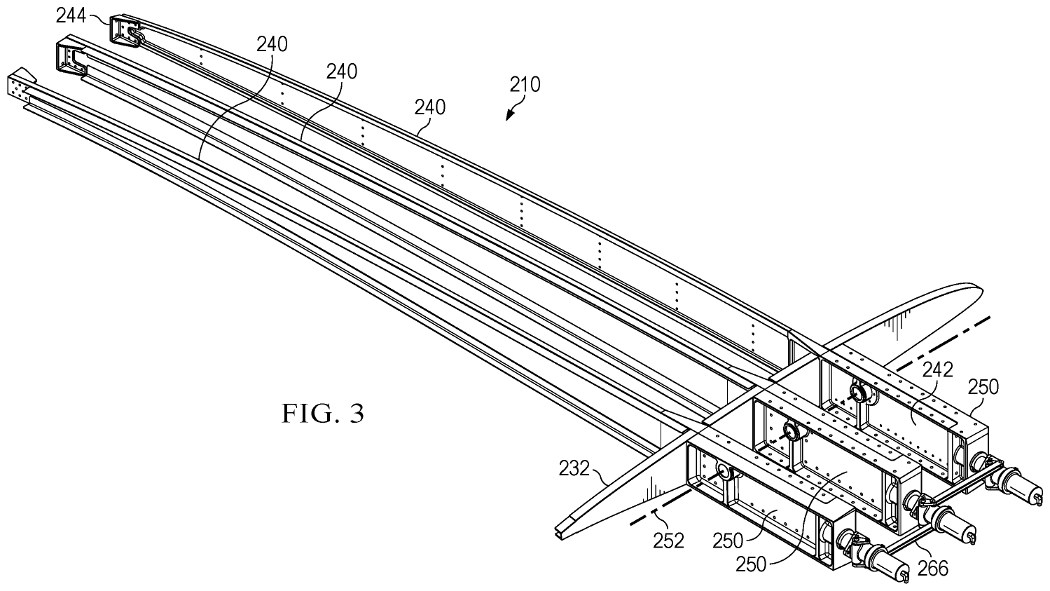

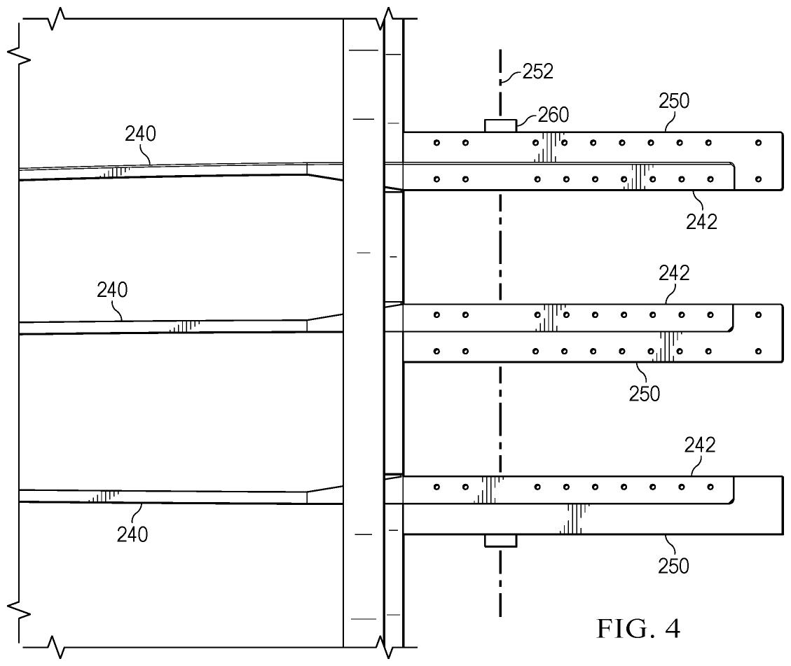

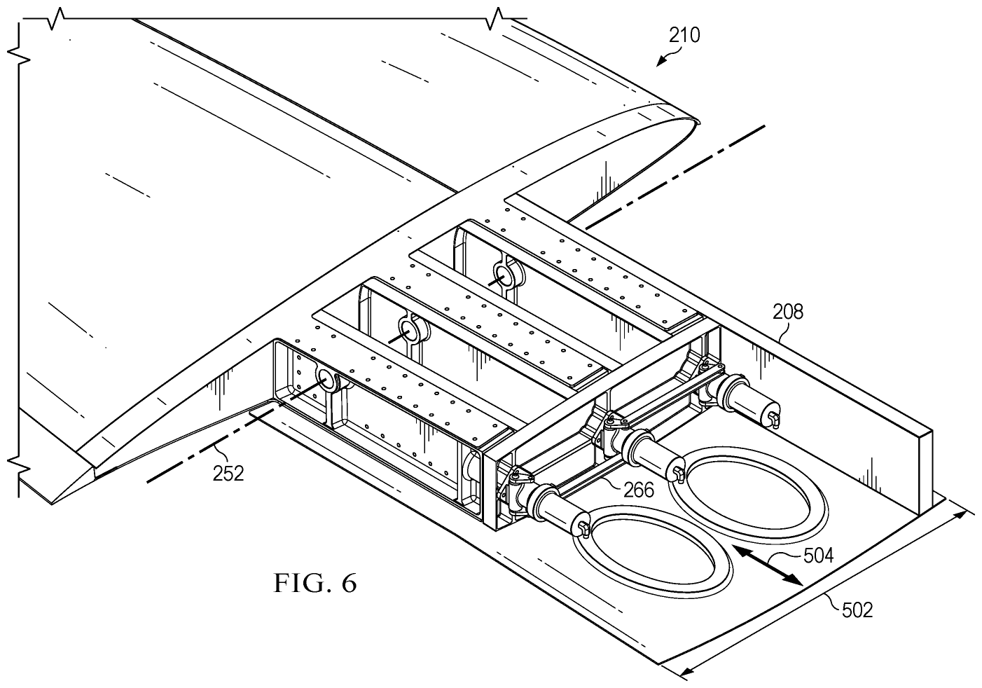

With reference next to FIGS. 3-6, illustrations of a folding wingtip are depicted in accordance with an illustrative embodiment. Set of spars 240 can be any number of spars. In this illustrative example, set of spars 240 includes at least three spars. Each spar of set of spars 240 has inboard end 242 and outboard end 244. Each spar of set of spars 240 is arranged parallel to each of the other spars of set of spars 240. Set of spars 240 carry the bending moment of wingtip section 210. When wingtip section 210 folds with respect to main section 208 about hinge line 252, set of spars 240 carries the majority of the bending moment associated with wingtip section 210 during folding as it folds with respect to main section 208 and during flight operations.

Set of hinge fittings 250 are connected to set of spars 240. A respective hinge fitting of set of hinge fittings 250 is connected to inboard end 242 of each spar of set of spars 240. The inboard ends of each spar of set of spars 240 extends through inboard closeout rib 232. A respective hinge fitting of set of hinge fittings 250 is connected to each inboard end 242 of each spar of set of spars 240 that extends through closeout rib 232. Hinge line 252 passes through each hinge fitting of set of hinge fittings 250. Hinge line 252 also passes through each inboard end 242 of each spar of set of spars 240. Hinge line 252 is perpendicular to each spar of set of spars 240. Hinge line 252 provides a pivot axis for folding wingtip section 210 with respect to main section 208.

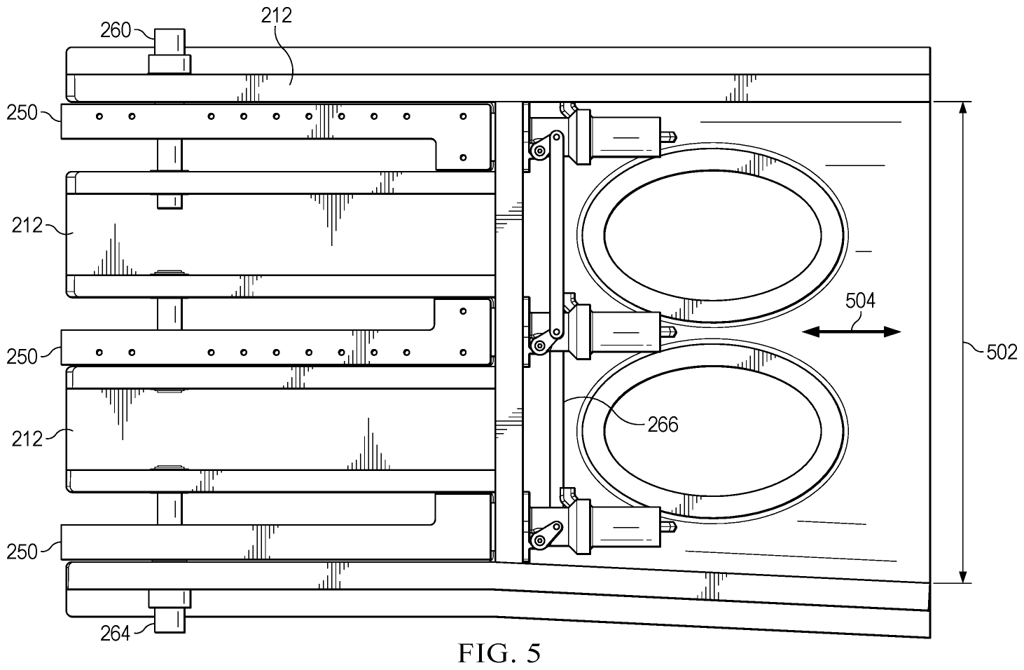

Actuator 260 (shown in FIG. 5) is mounted to set of hinge fittings 250 or set of beams 212. Actuator 260 may be a dual actuator, where each actuator works simultaneously or independently to initiate the movement/folding of wingtip section 210. Actuator 260 motivates the movement of wingtip section 210 relative to main section 208 about hinge line 252. Actuator 260, as depicted, is a non-limiting example of structure that is capable of imparting a force to cause rotational movement of the wingtip section relative to the main section of the wing. Other mechanical structures that are capable of imparting the force to cause the rotational movement of the wingtip section relative to the main section are considered as well.

Shock damper 264 is mounted to set of hinge fittings 250 or set of beams 212. Shock damper 264 prevents abrupt starts and starts of the movement of wingtip section 210 relative to main section 208 and prevents fatigue of wingtip section 210.

Set of latch pins 266 is removably engaged with set of hinge fittings 250. In an illustrated example, a respective latch pin of set of latch pins 266 is removably engaged with each respective hinge fitting of set of hinge fittings 250. Set of latch pins 266 engage set of hinge fittings 250 to secure wingtip section 210 in deployed position 704. When set of latch pins 266 is engaged with set of hinge fittings 250, wingtip section 210 cannot pivot about hinge line 252. Set of latch pins 266 are evenly distributed along hinge line 152 over distance 502. This distributes forces evenly between each latch pin of set of latch pins 266. Set of latch pins 266 move with respect to set of hinge fittings 250 in direction 504. Direction 504 is parallel with each spar of set of spars 240.

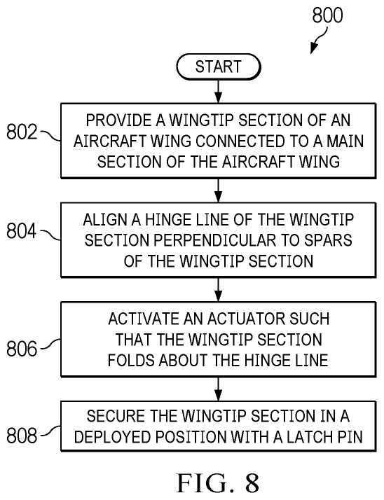

With reference next to FIG. 8, an illustration of a flowchart of a process 800 for folding a wingtip is depicted in accordance with an illustrative embodiment. The method depicted in FIG. 8 may be used in conjunction with the wing depicted in FIGS. 1-7.

The process begins by providing a wingtip section of an aircraft wing that is connected to a main section of the aircraft wing (operation 802). The wingtip section includes at least three spars arranged parallel with each other. The wingtip section also includes a respective hinge fitting connected to a respective inboard end of each spar of the spars. The process continues by aligning a hinge line of the wingtip section perpendicular to the spars (operation 804). The hinge line passes through each respective hinge fitting. At operation 806, the process activates an actuator to fold the wingtip section about the hinge line. The hinge line provides a pivot axis for the wingtip section relative to the main section. At operation 808, once the wingtip section is unfolded relative to the main section, the process secures the wingtip section in a deployed position with a latch pin. The latch pin extends in a direction parallel with the spars into each respective hinge fitting. The set of latch pins are evenly distributed along the hinge line.

In some alternative implementations of an illustrative example, the function or functions noted in the blocks may not be necessary or may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

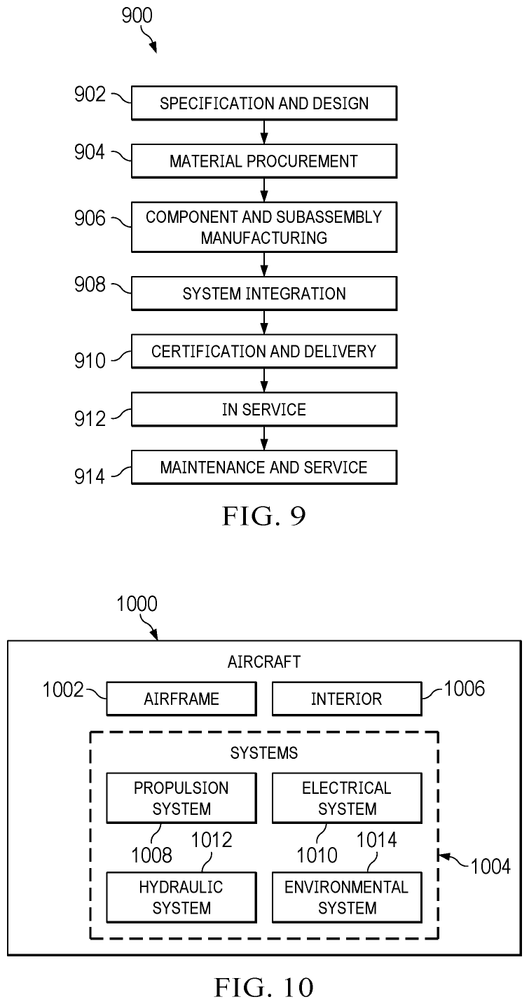

The illustrative embodiments of the disclosure may be further described in the context of aircraft manufacturing and service method 900 as shown in FIG. 9 and aircraft 1000 as shown in FIG. 10. Turning first to FIG. 9, an illustration of a block diagram of an aircraft manufacturing and service method is depicted in accordance with an illustrative embodiment. During pre-production, aircraft manufacturing and service method 900 may include specification and design 902 of aircraft 1000 in FIG. 10 and material procurement 904.

During production, component and subassembly manufacturing 906 and system integration 908 of aircraft 1000 in FIG. 10 takes place. Thereafter, aircraft 1000 in FIG. 10 may go through certification and delivery 910 in order to be placed in service 912. While in service 912 by a customer, aircraft 1000 in FIG. 10 is scheduled for routine maintenance and service 914, which may include modification, reconfiguration, refurbishment, and other maintenance, service, or inspection.

The apparatus of this disclosure may be installed on an aircraft during component and subassembly manufacturing 906. In addition, the apparatus of this disclosure may be retrofitted onto aircraft 1000 in FIG. 10 during routine maintenance and service 914 as part of a modification, reconfiguration, or refurbishment of aircraft 1000 in FIG. 10.

Each of the processes of aircraft manufacturing and service method 900 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers, and an operator may be an airline, a leasing company, a military entity, a service organization, and so on.

With reference now to FIG. 10, an illustration of a block diagram of an aircraft is depicted in which an illustrative embodiment may be implemented. In this example, aircraft 1000 is produced by aircraft manufacturing and service method 900 in FIG. 9 and may include airframe 1002 with plurality of systems 1004 and interior 1006. Examples of systems 1004 include one or more of propulsion system 1008, electrical system 1010, hydraulic system 1012, and environmental system 1014. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 900 in FIG. 9. In one illustrative example, components or subassemblies produced in component and subassembly manufacturing 906 in FIG. 9 may be fabricated or manufactured in a manner similar to components or subassemblies produced while aircraft 1000 is in service 912 in FIG. 9. As yet another example, one or more apparatus embodiments, method embodiments, or a combination thereof may be utilized during production stages, such as component and subassembly manufacturing 906 and system integration 908 in FIG. 9. One or more apparatus embodiments, method embodiments, or a combination thereof may be utilized while aircraft 1000 is in service 912, during maintenance and service 914 in FIG. 9, or both. The use of a number of the different illustrative embodiments may substantially expedite the assembly of aircraft 1000, reduce the cost of aircraft 1000, or both expedite the assembly of aircraft 1000 and reduce the cost of aircraft 1000.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A folding wingtip of a wing of an aircraft, comprising:
a spar;
a hinge fitting connected to an inboard end of the spar; and
a hinge line passing through the hinge fitting and perpendicular to the spar, wherein the folding wingtip is configured to be pivotally connected to a main section of the wing and wherein the hinge line is a pivot axis for the folding wingtip with respect to the main section.

2. The folding wingtip of claim 1, further comprising:
a latch pin removably engaged with the hinge fitting, wherein when the latch pin is engaged with the hinge fitting, the folding wingtip cannot pivot about the hinge line.

3. The folding wingtip of claim 2, wherein the latch pin moves with respect to the hinge fitting in a linear direction parallel with the spar.

4. The folding wingtip of claim 1, wherein the spar further comprises:
at least three spars arranged parallel with each other; and
a respective hinge fitting connected to an inboard end of each spar, wherein the hinge line passes through each respective hinge fitting and is perpendicular to each of the at least three spars.

5. The folding wingtip of claim 4, further comprising:
a set of latch pins, wherein a respective latch pin of the set of latch pins is removably engaged with each respective hinge fitting.

6. The folding wingtip of claim 5, wherein the set of latch pins are evenly distributed in a direction along the hinge line.

7. The folding wingtip of claim 4, further comprising:
stiffened panels connected to the at least three spars, the stiffened panels forming a leading edge bullnose and a trailing edge wedge of the folding wingtip.

8. The folding wingtip of claim 4, wherein a majority of a bending moment of the folding wingtip is carried in the at least three spars.

9. An aircraft wing with a folding wingtip, comprising:
a main section connected to a fuselage of an aircraft; and
a wingtip section pivotally connected to the main section;
the wingtip section comprising:
at least three spars arranged parallel with each other;
a respective hinge fitting connected to a respective inboard end of each spar of the at least three spars, each spar and each respective hinge fitting pivotally connected to the main section; and
a hinge line perpendicular to each spar of the at least three spars, wherein the hinge line is a pivot axis for folding the at least three spars and each respective hinge fitting relative to the main section.

10. The aircraft wing of claim 9, wherein the hinge line passes through each respective hinge fitting and each respective inboard end of each spar.

11. The aircraft wing of claim 9, further comprising:
a latch pin removably engaged with the respective hinge fitting, wherein when the latch pin is engaged with the respective hinge fitting, the at least three spars cannot fold about the hinge line.

12. The aircraft wing of claim 11, wherein the latch pin moves with respect to the respective hinge fitting in a direction parallel with the at least three spars.

13. The aircraft wing of claim 9, further comprising:
a set of latch pins, wherein a respective latch pin of the set of latch pins is removably engaged with each respective hinge fitting.

14. The aircraft wing of claim 13, wherein the set of latch pins are evenly distributed in a direction along the hinge line.

15. The aircraft wing of claim 9, further comprising:
stiffened panels connected to the at least three spars, the stiffened panels forming a leading edge bullnose and a trailing edge wedge of the wingtip section.

16. The aircraft wing of claim 9, wherein a majority of a bending moment of the wingtip section is carried in the at least three spars.

17. The aircraft wing of claim 9, wherein the main section further comprises a set of parallel beams sized and shaped to fit between the respective hinge fittings, and wherein the hinge line passes through each beam of the set of parallel beams.

18. A method for folding a wingtip, comprising:
providing a wingtip section of an aircraft wing pivotally connected to a main section of the aircraft wing, wherein the wingtip section comprises at least three spars arranged parallel with each other and a respective hinge fitting connected to a respective inboard end of each spar of the at least three spars;
aligning a hinge line of the wingtip section perpendicular to the at least three spars of the wingtip section, wherein the hinge line passes through each respective hinge fitting and each spar; and
activating an actuator such that the wingtip section folds about the hinge line, wherein the hinge line provides a pivot axis for the wingtip section to rotate relative to the main section.

19. The method of claim 18, wherein the wingtip section has a folded position and a deployed position, the method further comprising:
securing the wingtip section in the deployed position with a latch pin extending in a linear direction parallel with the at least three spars into each respective hinge fitting.

20. The method of claim 18, wherein the wingtip section has a folded position and a deployed position, the method further comprising:
securing the wingtip section in the deployed position with a set of latch pins engaged with the at least three spars, wherein the set of latch pins are evenly distributed along the hinge line.
